(19) United States
(12) Patent Application Publication
(10) Pub. No.: US 2011/0250492 A1
(43) Pub. Date: Oct. 13, 2011

(54) BATTERY CASE, BATTERY CASE MANUFACTURING METHOD, AND BATTERY CASE MANUFACTURING APPARATUS USED FOR THE METHOD

(75) Inventor: Junji KAGEYAMA, Kuki-shi (JP)

(73) Assignee: SANSHU INDUSTRY CO., LTD., Saitama (JP)

(21) Appl. No.: 13/045,559

(22) Filed: Mar. 11, 2011

(30) Foreign Application Priority Data
Apr. 9, 2010 (JP) 2010-089985

(51) Int. Cl. H01M 2/02; H01M 10/04

(52) U.S. Cl. 429/176; 29/623.1

(57) ABSTRACT

To achieve sufficient heat dissipation of a battery case when many batteries are stacked up,
a battery case (1) is manufactured by using a die (12) having a cavity (13) and a punch (14) having a front end portion capable of being inserted into the cavity (13), filling a slag (15) in the cavity (13), and moving down the punch (14) to impulsively press the slag (15) and plastically deform the slag (15), where the cavity is structured such that enlarged portions (17) are formed by expanding at least four corner portions or parts of the other portions than the four corner portions to an outer peripheral side of the cavity (13) to obtain the battery case provided with the ribs (3) extending in a height direction at least on the four corner portions or the outer sides of the other portions than the four corner portions.

### BACKGROUND OF THE INVENTION

1. Field of the Invention

The present invention relates to a battery case mainly used for a hybrid car or an electric car, a manufacturing method of the same, and a battery case manufacturing apparatus used for the method, and more particularly to a battery case which is manufactured by an impact press method, a manufacturing method of the same, and a battery case manufacturing apparatus used for the method.

2. Description of the Conventional Art

In recent years, as a battery used for a hybrid car and an electric car, a lithium ion battery is employed, while, as a battery case of the lithium ion battery, a box type closed-end container having an approximately rectangular shape in a plan view is used, and there is a case that an impact press method is employed at a time of manufacturing the battery case.

A description will be hereunder given of the method of manufacturing the battery case in accordance with the impact press method with reference to the accompanying drawings. FIG. 10 is a perspective view showing a process of manufacturing the battery case in accordance with the impact press method, and FIG. 11 is a sectional view showing a state in which the battery case is being manufactured by the impact press.

In the figures, in the case of manufacturing the battery case in accordance with the impact press method, there are used a die 31 in which a cavity 32 is formed, a slag 33 which is filled in the cavity 32 in the die 31, and a punch 34 in which a front end portion is inserted into the cavity 32 by being moved down toward the die 31.

First of all, the slag 33 which is a chunk of a metal such as aluminum or the like serving as a raw material of the battery case is filled in the cavity 32.

Then, a front end portion of the punch 34 is inserted into the cavity 32 by moving down the punch 34 in this state, thereby impulsively pressing the slag 33.

Accordingly, as shown in FIG. 11, the slag 33 within the cavity 32 plastically deforms so as to extend upward along an outer periphery of the punch 34, whereby the battery case is manufactured.

Therefore, in the case of manufacturing the battery case in accordance with the impact press method, there is an advantage that a reduced number of metal molds are necessary in comparison with the case of manufacturing by, for example, a deep draw press or the like, and a material loss lessens.

As for the prior art, reference is made to Japanese Unexamined Patent Publication No. 2000-176588 and Japanese Unexamined Patent Publication No. 2000-197913.

### SUMMARY OF THE INVENTION

### Problem to be Solved by the Invention

In the meantime, in the hybrid car and the electric car, a battery unit is constructed by collecting a lot of batteries. For example, about forty to fifty batteries are used in a hybrid car, and about three hundreds of batteries are used in an electric car.

At this time, strength is demanded in the battery case for stacking up a lot of batteries, when unitizing the batteries.

However, as for the battery case which has been provided conventionally, since a thickness of a side wall is uniform, it is impossible to obtain sufficient strength, and in the case of stacking up a lot of batteries, there is a distinct possibility of a risk of product deterioration and performance deterioration caused by a deformation or the like.

Further, as for the battery in the hybrid car and the electric car, charge and discharge of a great current are frequently done at a time of traveling, whereby heat is generated. However, at this time, since a lot of batteries are stacked up and are used in a unitized form as mentioned above, heat dissipation is particularly important for the battery in the hybrid car and the electric car in order to prevent the product deterioration and the performance deterioration.

However, as for the conventional battery case, a method of enhancing the heat dissipation performance as mentioned above has not been particularly employed. Accordingly, there has been a possibility of the problem that sufficient heat dissipation cannot be made.

Therefore, an object of the present invention is to obtain a battery case which can achieve sufficient heat dissipation even in the case that a lot of batteries are stacked up so as to be unitized.

### Means for Solving the Problem

In accordance with the present invention, there is provided a battery case for accommodating batteries, the battery case comprising:

a case main body formed in a closed-end box shape; and

ribs formed on at least four corner portions of the case main body or outer sides of the other portions than the four corner portions so as to extend over in a height direction of the case main body.

Further, in accordance with the present invention, there is provided a manufacturing method of the battery case, where a die which has a cavity, and a punch which is arranged so as to be relatively movable with respect to the die and has a front end portion capable of being inserted into the cavity when moved down, are used, a slag serving as a battery case material is filled in the cavity, the punch is moved down to thereby insert the front end portion of the punch into the cavity and impulsively press the slag, and the slag is thereby plastically deformed to manufacture a battery case in a desired shape,

wherein the cavity which is structured such that enlarged portions are formed by expanding at least four corner portions or parts of the other portions than the four corner portions to an outer peripheral side of the cavity, is used.

Further, in accordance with the present invention, there is provided a battery case manufacturing apparatus used for the manufacturing method of the battery case, the manufacturing apparatus comprising

a die which has a cavity, a punch which is arranged so as to be relatively movable with respect to the die and has a front end portion capable of being inserted into the cavity when moved down, and being operated such that a slag serving as a battery case material is filled in the cavity, the punch is moved down to thereby insert the front end portion of the punch into the cavity and impulsively press the slag, and the slag is thereby plastically deformed to manufacture a battery case in a desired shape,

wherein the cavity has a cavity main body in which the slag is filled, and enlarged portions which are formed by expanding at least four corner portions of the cavity main body or parts of the other portions than the four corner portions to an outer peripheral side of the cavity.

### Effect of the Invention

The battery case in the present invention is provided with the ribs which are formed on at least four corner portions of the case main body or on the outer sides of the other portions than the four corner portions so as to extend over in the height direction of the case main body.

Accordingly, it is possible to enhance strength of the whole of the case on the basis of the existence of the ribs, and it is possible to prevent product deterioration and performance deterioration even in the case that a lot of batteries are stacked up.

Further, since the ribs are provided, the ribs of the adjacent battery cases come into contact with each other in the case that a lot of batteries are stacked up, and spaces are formed in the other positions than those of the ribs. Accordingly, it is possible to dissipate heat in an inner portion of the battery via the spaces, and it is possible to obtain a battery case which is excellent in a heat dissipation performance and can prevent product deterioration and performance deterioration.

### BRIEF EXPLANATION OF THE DRAWINGS

FIG. 1 is a perspective view showing an embodiment of a battery case in accordance with the present invention;

FIG. 2 is a plan view of the embodiment of the battery case in accordance with the present invention;

FIG. 3 is a plan view of another structure of the battery case in accordance with the present invention;

FIG. 4 is a plan view of another structure of the battery case in accordance with the present invention;

FIG. 5 is a view for explaining an operation of the embodiment of the battery case in accordance with the present invention;

FIG. 6 is a view for explaining an operation of the other structure of the battery case in accordance with the present invention;

FIG. 7 is a view for explaining an operation of the other structure of the battery case in accordance with the present invention;

FIG. 8 is a view for explaining a die used for manufacturing the embodiment of the battery case in accordance with the present invention;

FIG. 9 is a view for explaining a method of manufacturing the embodiment of the battery case in accordance with the present invention;

FIG. 10 is a view for explaining a method of manufacturing a conventional battery case; and

FIG. 11 is a view for explaining a method of manufacturing a conventional battery case.

### DESCRIPTION OF REFERENCE NUMERALS

1 battery case
2 case main body
3 rib
4 battery
5 battery unit
6 space formed between stacked batteries
11 manufacturing apparatus of battery case
12 die
13 cavity
14 punch
15 slag
16 cavity main body
17 enlarged portion of cavity

### DETAILED DESCRIPTION OF PREFERRED EMBODIMENT

A battery case in accordance with the present invention has a case main body which is formed in a closed-end box shape, and ribs are formed at least on four corner portions of the case main body, or at least on an outer sides of the other portions than the four corner portions of the case main body, so as to extend over the whole region in a height direction of the case main body.

Further, the battery case in accordance with the present invention structured as mentioned above is manufactured by using a die which has a cavity, and a punch which is arranged so as to be relatively movable with respect to the die and has a front end portion capable of being inserted into the cavity when being moved down.

In particular, in the manufacturing method of the battery case in accordance with the present invention, the cavity which is structured such that enlarged portions are formed by expanding at least four corner portions or parts of the other portions than the four corner portions to an outer peripheral side of the cavity, is used in the method of manufacturing the battery case by filling a slag serving as a material of the battery case in the cavity, moving down the punch to insert the front end portion of the punch into the cavity and thereby impulsively press the slag, and plastically deforming the slag.

Further, a manufacturing apparatus of the battery case in accordance with the present invention for manufacturing the battery case mentioned above by employing this method is provided with a die which has a cavity, and a punch which is arranged so as to be relatively movable with respect to the die and has a front end portion capable of being inserted into the cavity when moved down, and the cavity has a cavity main body in which the slag is filled, and enlarged portions which are formed by expanding at least four corner portions of the cavity main body or parts of the other portions than the four corner portions to an outer peripheral side of the cavity, in the apparatus for manufacturing the battery case by filling a slag serving as a material in the cavity, moving down the punch to thereby insert the front end portion of the punch into the cavity and impulsively press the slag, and thereby plastically deforming the slag.

### Embodiment 1

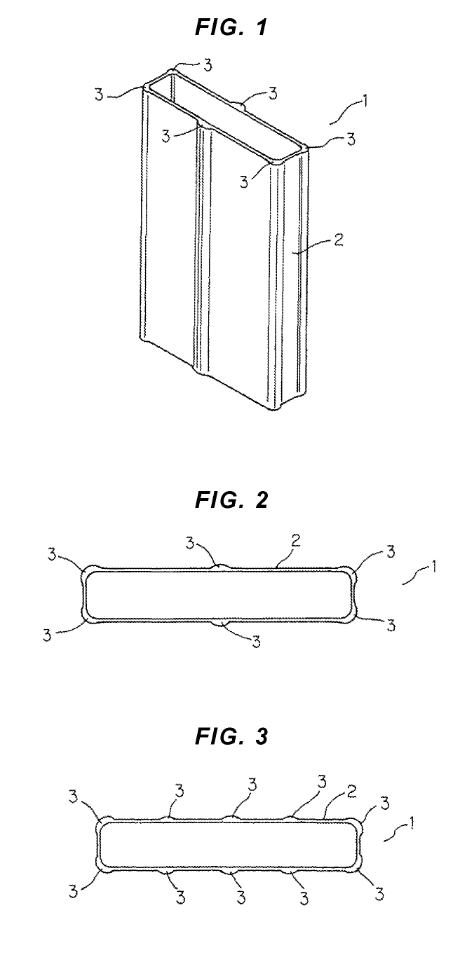

A description will be given of an embodiment of a battery case in accordance with the present invention with reference to the accompanying drawings. FIG. 1 is a perspective view of a battery case 1 in accordance with the present embodiment, and FIG. 2 is a plan view of the battery case in accordance with the present embodiment.

The battery case 1 in accordance with the present embodiment is formed as a battery case for accommodating a lithium ion battery which is used as a power supply of a hybrid car and an electric car, and is provided with a case main body and ribs which are formed on an outer peripheral side of the case main body.

In particular, in the figures, reference numeral 2 denotes a case main body, and the case main body 2 in the present embodiment is formed in a box shape having a closed-end and an open upper portion, while being formed in a rectangular shape in a plan view, a side view, a front view and a rear view, and battery constructing parts such as electrodes and the like of a lithium ion battery are accommodated in an inner portion thereof.

Further, the case main body 2 is structured, as shown in FIG. 1, such that ribs 3 are formed on its four corner portions, and respective approximately center portions in a longitudinal direction of a pair of side walls forming longitudinal sides in the plan view, over a whole region in a height direction so as to increase a thickness in a circular arc shape in the plan view.

Accordingly, in the battery case 1 in accordance with the present embodiment, it is possible to enhance strength on the basis of the existence of the ribs 3. Even in the case that they are stacked, it is possible to prevent product deterioration and performance deterioration from being caused, and it is possible to enhance a heat dissipation performance on the basis of the existence of the ribs 3, whereby it is possible to prevent product deterioration and performance deterioration from being caused.

FIG. 5 is a view for explaining an operation of the battery case 1 in accordance with the present embodiment, and FIG. 5 shows a state in which a battery unit 5 is constructed by stacking a lot of lithium ion batteries 4 with the battery cases 1 in accordance with the present embodiment. In the figure, since each of the battery cases 1 comes into contact with the adjacent battery cases by portions of the ribs 3, spaces 6 are formed between the adjacent battery cases 1, in the other portions than the ribs 3 of each of the battery cases 1.

Accordingly, it is possible to easily dissipate heat generated in each of the batteries 4 on the basis of the existence of the space 6. Therefore, it is possible to obtain a battery having a high heat dissipation performance.

In other words, when the battery unit 5 is constructed by stacking a lot of batteries 4 in the case that the ribs 3 do not exist, the batteries 4 come into close contact with each other by their side walls, so that it is impossible to dissipate heat from the side wall portion which comes into close contact with the adjacent battery case. Therefore, a portion for discharging the heat in an inner portion of the battery case is reduced, and a heat dissipation performance is deteriorated.

However, in the battery case 1 in accordance with the present embodiment, since the ribs 3 are provided, the battery case comes into contact with the adjacent battery cases by the portion of the ribs 3, the space 6 is formed between the adjacent battery cases in the other portions than the portion of the ribs 3 in each of the battery cases 1 in a state in which the battery unit 5 is constructed by stacking a lot of batteries 4, and the heat can be discharged into the space 6, it is possible to obtain a battery having a high heat dissipation performance.

In addition, in the embodiment mentioned above, the description is given of the structure in which the ribs 3 are formed on four corner portions of the case main body 2, and approximately the center portions in the longitudinal direction of the side walls forming the longitudinal sides in the plan view, however, this mode is not necessarily employed, but one rib or a plurality of ribs may be formed at optional positions of the case main body 2.

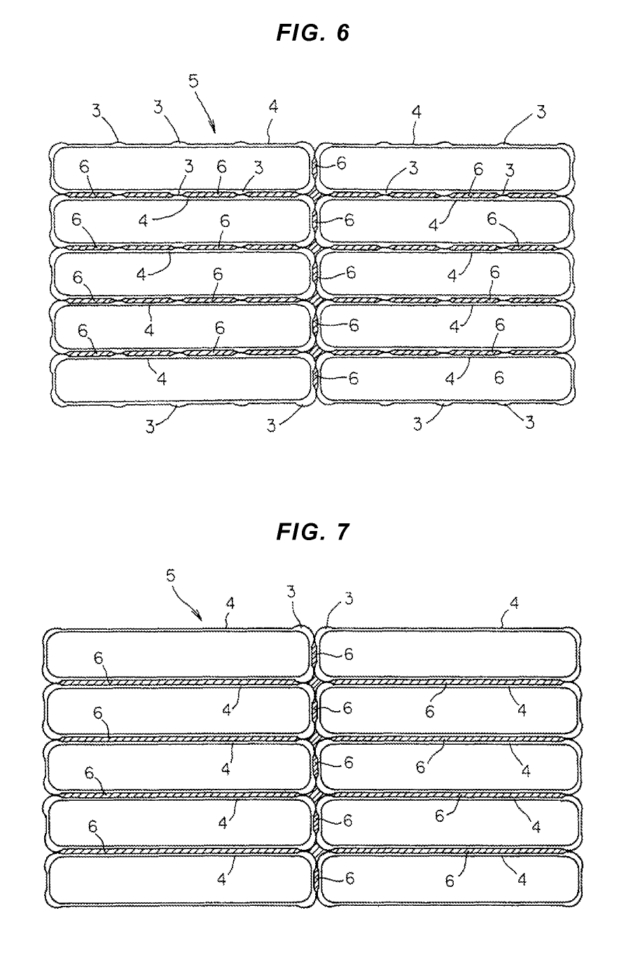

For example, FIG. 3 shows a structure in which the ribs 3 are formed at four corner portions of the case main body 2, and three positions of each of a pair of side walls forming the longitudinal sides in the plan view. Even in this case, it is possible to form the space between the battery cases 1 in a state in which the battery unit 5 is constructed by stacking a lot of battery cases, as shown in FIG. 6, and it is possible to enhance the heat dissipation performance.

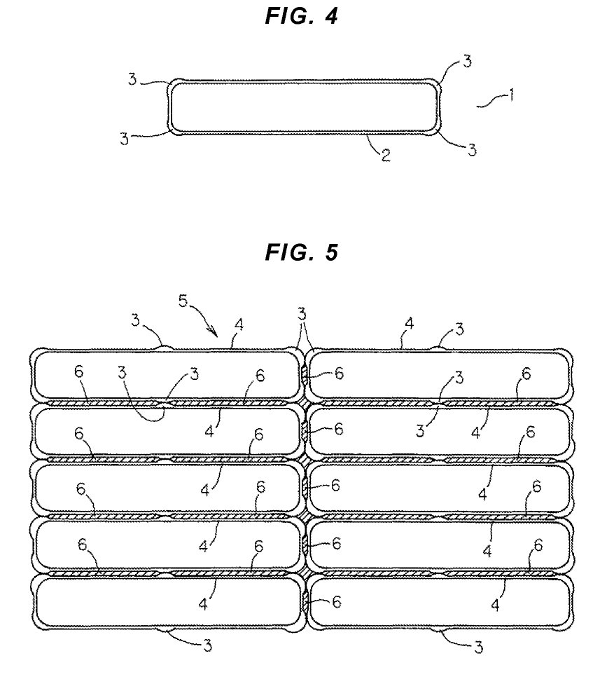

Further, FIG. 4 shows a case that the ribs 3 are formed only on four corner portions of the case main body 2. Even in this case, the space 6 can be formed between the battery cases 1 in a state in which the battery unit 5 is constructed by stacking a lot of battery cases, as shown in FIG. 7, and it is possible to enhance the heat dissipation performance. In this case, in FIGS. 5, 6 and 7, the portions of the spaces 6 are shown by hatched lines, for easily understanding.

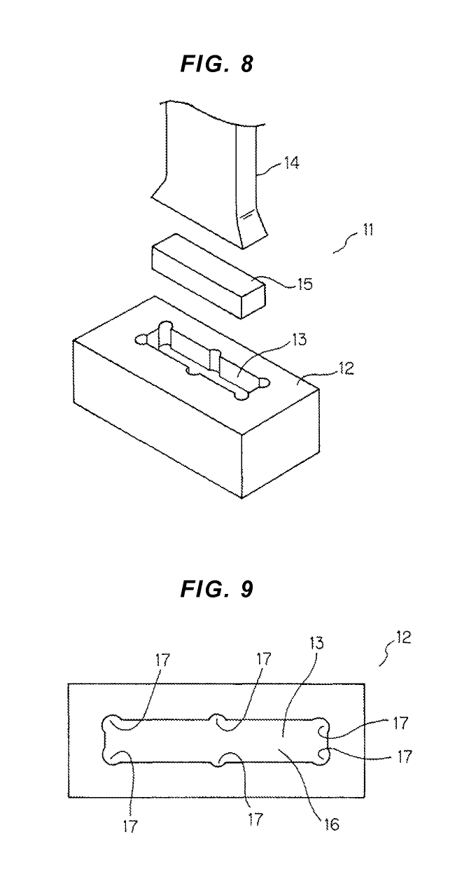

Next, a description will be given of an embodiment of a manufacturing apparatus for manufacturing the battery case 1 constructed as mentioned above with reference to the accompanying drawings. FIG. 8 is a schematic view for explaining a manufacturing apparatus 11 of the battery case in accordance with the present embodiment. The manufacturing apparatus 11 of the battery case in accordance with the present embodiment has a die and a punch similarly to the conventional manufacturing apparatus mentioned above.

In particular, in the figure, reference numeral 12 denotes a die, the die 12 in the present embodiment is formed in a cuboid shape or a cubic shape in the same manner as the die which is generally used in an impact press, a cavity 13 is formed in a flat surface side, and a slag serving as a raw material is filled in the cavity 13. In this case, an outer shape of the die 12 is not particularly limited, and may be formed in a cylindrical shape.

Next, in the figure, reference numeral 14 denotes a punch, and the punch 14 in the present embodiment is structured such as to be movable in a vertical direction with respect to the die 12 in the same manner as the conventional punch, has an outer diameter which is slightly smaller than an inner diameter of the cavity 13, and is structured such that a front end portion is inserted into the cavity 13 when moved down.

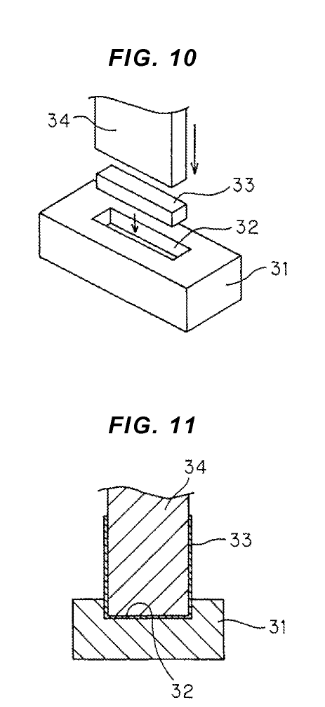

Then a description will be given in detail of the cavity 13. FIG. 9 is a plan view of the die 12. In the figure, the cavity 13 in the present embodiment has a cavity main body 16, four corner portions of the cavity main body 16, and enlarged portions 17 formed at the respective center portions in a longitudinal direction of a pair of side wall portions constructing longitudinal sides of the cavity main body 16.

In other words, in the figure, reference numeral 16 denotes the cavity main body, and the cavity main body 16 in the present embodiment is formed by cutting the die 12 at a predetermined depth from a top surface, and has an inner dimension which is slightly larger than an outer dimension of the punch 14, as mentioned above, whereby a front end portion of the punch 14 can be inserted into an inner portion thereof.

Four corner portions of the cavity main body 16 in the present embodiment are expanded in a circular arc shape toward an outer side of the cavity main body 16 over a whole region in a depth direction, whereby the enlarged portions 17 are formed at four corner portions of the cavity main body 16.

Further, a pair of enlarged portions 17 are formed in the same manner in each of side walls forming a longitudinal sides of the cavity main body 16, over a whole region in a depth direction of the cavity main body 16 so as to be expanded in a circular arc shape toward an outer side of the cavity main body 16. Further, a pair of enlarged portions 17 are formed at the center portions in the longitudinal direction, of aside walls forming the longitudinal sides of the cavity main body 16.

Accordingly, in the case that the battery case 1 is manufactured in accordance with an impact press method by using the manufacturing apparatus 11 of the battery case constructed as mentioned above, the ribs 3 in which the thickness is increased in a circular arc shape in the plan view, over the whole region in a height direction are provided on four corner portions of the case main body 2, and approximately the center portions in the longitudinal direction of the side walls forming the longitudinal sides of the case main body in the plan view, as shown in FIG. 1, and it is possible to obtain the battery case 1 in which the strength is high and the heat dissipation performance is high.

In this case, the enlarged portions 17 are not necessarily formed at four corner portions of the cavity main body 16, and the respective center portions in the longitudinal direction of a pair of side walls forming the longitudinal sides of the cavity main body 16, but may be formed at optional positions of the cavity main body 16 in correspondence to positions on the battery case to be manufactured where the ribs are formed. Therefore, in the case of manufacturing the battery case as shown in FIG. 3, there is employed the die 12 having the cavity 13 in which the enlarged portions 17 are formed at four corner portions of the cavity main body 16, and respective three positions aligned in the longitudinal direction of a pair of side walls forming the longitudinal sides of the cavity main body 16, and in the case of manufacturing the battery case as shown in FIG. 4, there is employed the die 12 having the cavity 13 in which the enlarged portions 17 are formed only at four corner portions of the cavity main body 16.

Next, a description will be given of a method of manufacturing the battery case 1 by using the manufacturing apparatus 11 of the battery case constructed as mentioned above. Reference numeral 15 in FIG. 8 denotes a slag serving as a raw material of the battery case 1, and a metal such as aluminum or the like is used.

In the manufacturing method of the battery case in accordance with the present embodiment, first of all, the slag 15 is filled in the cavity main body 16 of the cavity 13, in FIG. 8.

Next, the punch 14 is moved down in this state, whereby a front end portion of the punch 14 is inserted into the cavity main body 16, and the slag 15 is impulsively pressed by the front end portion of the punch 14.

Accordingly, the slag 15 plastically deformed upward along an outer periphery of the punch 15 in the same manner as shown in FIG. 11 mentioned above, on the basis of impulsive pressing by the punch 14, thereby deforming into the box shaped battery case 1.

At this time, in the manufacturing apparatus of the battery case in accordance with the present embodiment, since the cavity 13 formed in the die 12 is constructed of the cavity main body 16, and the enlarged portions 17 which are formed by expanding in a circular arc shape toward the outer side of the cavity main body 16 over a whole region in a depth direction of the cavity main body 16 at four corner portions of the cavity main body 16 and a pair of side walls forming the longitudinal sides of the cavity main body 16, it is possible to provide the ribs 3 in which the thickness is increased in the circular arc shape in the plan view, over the whole region in a height direction, on four corner portions of the battery case 1 and the respective approximately center portions in the longitudinal direction of a pair of side walls forming the longitudinal sides of the battery case 1 in the plan view, in a process that the slag 15 plastically deforms upward by the impulsive pressing of the punch 14 so as to deform into the box shaped battery case 1.

Therefore, it is possible to manufacture the battery case by a reduced number of metal molds, and with a reduced material loss, in accordance with the method of the present embodiment, and the manufactured battery case can be provided with the ribs in which the thickness is increased in the circular arc shape in the plan view, over a whole region in the height direction on its four corner portions and approximately the center portions in the longitudinal direction of the side walls forming the longitudinal sides of the battery case in the plan view.

### INDUSTRIAL APPLICABILITY

In accordance with the present invention, since the ribs are provided at least on four corner portions and outer sides of the other portions than the four corner portions, whereby it is possible to obtain the battery case which is high in its strength and its heat dissipation performance, it is possible to apply to all the battery cases.

What is claimed is:

1. A battery case (1) for accommodating battery constructing parts, the battery case comprising:
a case main body (2) formed in a closed-end box shape; and
ribs (3) formed on at least four corner portions of said case main body (2) or outer sides of the other portions than the four corner portions so as to extend over in a height direction of the case main body (2).

2. A manufacturing method of the battery case (1) as claimed in claim 1, where a die (12) which has a cavity (13), and a punch (14) which is arranged so as to be relatively movable with respect to said die (12) and has a front end portion capable of being inserted into said cavity (13) when moved down, are used, a slag (15) serving as a material is filled in said cavity (13) said punch (14) is moved down to thereby insert the front end portion of said punch (14) into said cavity (13) and impulsively press said slag (15), and said slag (15) is thereby plastically deformed to manufacture the battery case (1),
wherein said cavity (13) which is structured such that enlarged portions (17) are formed by expanding at least four corner portions or parts of the other portions than the four corner portions to an outer peripheral side of the cavity (13), is used.

3. A battery case manufacturing apparatus used for the manufacturing method of the battery case as claimed in claim 2, the manufacturing apparatus comprising a die (12) which has a cavity (13), and a punch (14) which is arranged so as to be relatively movable with respect to said die (12) and has a front end portion capable of being inserted into said cavity (13) when moved down, and being operable such that a slag (15) serving as a battery case material is filled in said cavity (13), said punch (14) is moved down to thereby insert the front end portion of said punch (14) into said cavity (13) and impulsively press said slag (15), and said slag (15) is thereby plastically deformed to manufacture the battery case (1),
wherein said cavity (13) has a cavity main body (16) in which the slag (15) is filled, and enlarged portions (17) which are formed by expanding at least four corner portions of said cavity main body (16) or parts of the other portions than the four corner portions to an outer peripheral side of the cavity (13).
